(19) United States
(12) Patent Application Publication
(10) Pub. No.: US 2014/0212846 A1
(43) Pub. Date: Jul. 31, 2014

(54) Coupler Alarm and Instructional Guide

(71) Applicants: Gary Miller, Cramlington (GB); Howard Reay, Washington (GB)

(72) Inventors: Gary Miller, Cramlington (GB); Howard Reay, Washington (GB)

(73) Assignee: MILLER INTERNATIONAL LTD., Gibraltar (GI)

(21) Appl. No.: 13/996,931

(22) PCT Filed: Dec. 19, 2011
(86) PCT No.: PCT/GB2011/001738

§ 371 Date: Apr. 11, 2014

(30) Foreign Application Priority Data
Dec. 21, 2010 (GB) 1021812.1

(51) Int. Cl. G09B 19/16

(52) U.S. Cl. CPC G09B 19/16
USPC 434/29

(57) ABSTRACT

An excavator (10) has a quick coupler (24) coupled to the distal end (22) of its excavator arm (12). The quick coupler (24) can be operated from the cab (14) of the excavator (10), and is connected to a warning control system (48) or an instructional device (102). The warning control system (48) is connected to a coupler control circuit (46), which controls the coupler (24) and the system or circuit acquires information on the coupler's status. A control system activation warning circuit is then arranged to be responsible for issuing warning signals (53, 54) to personnel located external of the cab when the coupler control circuit (46) is activated into an accessory coupling procedure mode, or an accessory decoupling procedure mode. To do this, the warning circuit (48) is coupled to an audio and/or visual alarm (50, 52) for directing the warnings (53, 54) to the personnel, including bystanders. The instructional device, however, instructs the operator as to how to use the coupler.

The present invention relates to a coupler alarm, and an instructional guide for a coupler for an excavator. In particular, it relates firstly to a coupler alarm which works to sound an alarm whenever either a coupling or an uncoupling procedure is taking place on the excavator, i.e. when buckets or other such accessories are being coupled to or uncoupled from an excavator arm of the excavator, and secondly for a device potentially for integrating therewith which provides instructions to the user.

Quick couplers are commonly fitted onto the free end of an excavator arm of an excavator. Quick couplers facilitate the automated coupling or decoupling of an accessory onto the end of the excavator arm. They can be semi automatic or fully automatic. Semi automatic couplers require a manual step to be carried out at the coupler, such as the removal of a safety pin, whereas fully automatic couplers can be fully operated wholly from within the cab of the excavator.

All of these forms of quick coupler, hereinafter a coupler, are fitted securely to the free end, i.e. the distal end, of the excavator's operating arm—the excavator arm, using attachment pins. The couplers then have jaws, or other engagement mechanisms, for engaging pins or the like of the accessory. As such, the couplers can allow different buckets, accessories or other heavy duty tools to be coupled and uncoupled to the operating arm.

In recent years, coupler technology has advanced considerably. Some advances have been driven by a demand for pure automation, i.e. the removal of all manual steps at the coupler. Other advancements have been driven by the desire for the coupling and decoupling procedures to be reliable, repeatable and fool proof. Yet further advancements have been to improve the reliability or number of redundant safety features, so as to require multiple failures within the coupler before there can be either an inadvertent detachment of the accessory from the coupler or an incorrect coupling of the coupler to the accessory. This is required since users are known to be in the occasional habit of failing to follow the correct coupling, or decoupling, procedures.

It is known in the art that an incorrect or inappropriate usage of a coupler can cause an accident. Further, it is known that a considerable proportion of all coupler-related accidents occur either during or shortly after a coupling or decoupling procedure, where the coupler has been incorrectly operated. As a result, it can be recognised that those periods of time present the period of time at which there is the greatest risk of an accident involving a bystander. It would therefore be desirable to reduce the level of risk to bystanders during that period of time

According to the present invention, there is provided: a quick coupler arrangement for an excavator, the quick coupler arrangement comprising a quick coupler with a coupling apparatus therein, a coupler control circuit with a control box, and a warning control system, the quick coupler's coupling apparatus being operable remote from the coupler via the coupler control box, and wherein the coupler or the coupler control circuit is in communication with the warning control system, the warning control system comprising a control system activation warning circuit that is coupled to an audio and/or visual alarm for directing warnings to personnel located at a position remote from the coupler control box when the coupler control circuit is activated into either an accessory coupling procedure mode or an accessory decoupling procedure mode. The warning thus warns the personnel in question that there is an increased risk in the area around the issued alarm, whereby that personnel can stay clear of that area.

The alarm can also feature a time delay, whereby the full attachment or detachment can be completed and verified before the alarm ceases to issue its warning. In many circumstances a 10 second time delay will be sufficient. The idea, therefore is that the alarm is on until the coupler is securely attached to the accessory, or work tool.

Preferably the present invention comprises an excavator having a cab, an excavator arm and a quick coupler coupled to its excavator arm, the quick coupler being as defined above.

Preferably the control box is located in the cab of the excavator.

The control system activation warning circuit can be adapted to detect the activation state of the coupler control circuit, and then trigger the warning when the status is detected to be either the accessory coupling procedure mode or the accessory decoupling procedure mode.

The connections, such as between the coupler and the control box, or between the control system activation warning circuit and the coupler control circuit, can be wired or wireless.

The warning control system effectively interlinks the coupler control system to the warning circuit.

The coupler control system is preferably adapted to assess and report the status or mode of the coupler to the central warning control system.

The warning circuit is responsible for the functioning of one or more alarm devices.

Preferably, the coupler control circuit is configured to be activated into an accessory coupling or decoupling procedure mode upon moving the excavator's arm to a crowd position—where the coupler is fully curled underneath the excavator arm. This crowd position is a position in which digging operations (including bucket-emptying) will not occur, and is thus a position frequently adopted as a “safe” commencement position for an uncoupling procedure.

Preferably the coupler is configured to be actuated between a coupling state and a decoupling state by the actuation of at least one hydraulic ram, the ram or rams operating the coupling apparatus within the coupler. That operation may be the opening of either one or two jaws of the coupler.

The coupler control circuit is configured to activate the or each ram during an accessory coupling or accessory decoupling procedure.

The detection of the mode of the coupler can be by detecting a pressure or flow in the coupler's hydraulic actuation circuit, such as a change of pressure or flow. The detection may be performed with simple pressure gauges positioned in the hydraulic circuit. These sensors will additionally be able to detect any malfunctioning of the hydraulic system, and will therefore be particularly suitable for this application.

Alternatively the detection of the mode occurs by monitoring the condition of the control box, such as for the pressing of buttons thereon.

Alternatively the detection of the mode can be by monitoring the position of the elements of the coupling apparatus within the coupler, such as by monitoring the position of any latches or blocking members thereof.

Preferably, the quick coupler comprises two jaws and a latch for one or both jaws. Either one or both latches may be provided with a blocking mechanism for preventing movement of that or those latches from a latching position (in which it secures a pin within the associated jaw) into a non latching position (in which the pin can vacate the associated jaw). A blocking bar mechanism is disclosed in GB2330570. Further blocking bar mechanism are shown in WO2008/029112, GB2450202, GB2467383, GB0916352.8, GB100201.8 and GB1013155.5 (the whole contents of which are all incorporated herein purely by way of reference) and also in other prior art documents. The alarm system can be integrated into coupler arrangements utilising any of these designs, and for example using a sensor on any one or more of the moving elements thereof—moving elements of one or both of the latching/blocking/securing means.

Preferably the or each latch is power operated, and the or each blocking mechanism is either power or gravity operated.

It is preferred to have a powered blocking bar (or blocking member), with it having a default bias towards a blocking position. The power operation is then to move it into a non blocking position. A sensor can then be provided for detecting the position of that blocking bar. The sensor could be on the frame of the coupler, or it could be on the bar itself, or it could be on the control mechanism for the blocking bar (such as on or on the hydraulic circuit, where the blocking bar is powered by a ram). With this arrangement, the sensor may detect for the locating of the blocking bar in a non blocking position, and it then triggering a warning whenever that occurs. After all, if it is not in a non blocking position, it will be in a blocking position (due to the bias thereto), thus rendering the coupler secure against an inadvertent release of an accessory. This arrangement also has an advantage in that many designs of blocking bar has more than one blocking position—each for a different accessory pin format (different pin spacings). See, for example, GB2330570. To detect the blocking bar's status in those blocking positions would thus potentially require multiple sensors—one for each blocking position. Detecting just the single non-blocking position can thus reduce the overall cost of providing the sensors. Further it avoids multiple false indications as the bar passes through the various blocking positions into a default blocking position for a given hook position (the position of the hook suiting the given accessory's attachment pin spacing)

The warning control system may monitor the positions of the latches, or the positions of the blocking mechanisms, or the positions of the pins within the jaws, or the positions of the pins relative to the latches, or the position of the coupler or arm relative to the cab of the excavator, or other active or moveable components of the blocking or latching mechanisms of the coupler, or the power mechanisms thereof, such as in the ram for the hook (or the blocking bar) or in one or more of the hydraulic valve(s) for such rams. Movements of members suggesting the commencement of a decoupling procedure, or suggesting the commencement of a coupling procedure, can thus then trigger an indication of a coupling or decoupling procedure mode. For this purpose, the coupler may comprise one or more latch sensor, one or more blocking mechanism sensor or one or more pin sensor in the or each jaw, the or each latch or the or each blocking mechanism, or any other such moving, or active, component(s). Likewise the cab or the arm, or the hydraulics of the arm, may comprise one or more sensor.

The coupler control circuit can have a switch or button for changing a mode of the coupler control circuit. The control system activation warning circuit can then be manually switched, e.g. by that switch or button, into issuing its warnings.

A personnel proximity sensor may also be provided for activating the alarm or warning. For example, a PIR sensor could be mounted on the excavator arm, on the coupler, on the accessory or on the excavator for watching for the heat signature of a person. Then, if someone or something with a heat signature passes near the operational reach of the excavator, a warning can be triggered.

The warning may alternatively be automatically switched on or off whenever the coupler is moved into a crowd position with respect to the excavator, i.e. with the coupler fully curled underneath the arm and towards the cab of the excavator—a position often adopted as being a required starting position for a coupling or decoupling procedure, e.g. for disengaging a gravity operated blocking mechanism within the coupler.

Preferably, the warning comprises an audio warning,—one that can easily be heard, such as by having a loudness in excess of 60 dB.

Preferably, the warning is at least partially in the format of a verbal or speech warning. This allows the purpose of the warning, or the form of the increased risk, to be stated, and thus easily understood. The warning, for example, may state “warning—coupling procedure active” or “warning—decoupling procedure active”, or simply “stand clear”

Preferably, the warning is at least partially in the form of a siren warning or an alarm tone or bell. These forms of sound have a universal understanding, and thus do not require a bystander to have a specific understanding of the language of the verbal warning, although the language of any provided language specific warning can be altered or set dependent upon the country in which the coupler or excavator, or coupler alarm system is sold or supplied.

Preferably, the warning comprises a mixture of speech and siren/alarm-style warnings.

Preferably, the alarm is located on, or built into, one or more components of the excavator. However, it might alternatively be mounted onto the coupler. Preferably it is located in more than one location, there being two or more alarms. Preferably an audio alarm and at least one visual alarm are provided.

Preferably, the warning comprises a visual warning, such as a flashing light. Such lights are widely associated with dangerous situations. Such flashing lights include the form of light with a rotating reflector therein.

The visual and audio alarm units can be formed as a single integrated unit. Such a unit can be more quickly fitted as a retrofit unit onto the excavator.

Preferably, the warning control system comprises a unit attached to, or attachable torn the control box, or operator interface, located in the cab. The operator interface or control box provides the controls for controlling the coupler.

The present invention also provides a warning control system for a quick coupler of an excavator; the system comprising an activation warning circuit and one or more alarm units, each for retro-fitting to an excavator that has a coupler and a coupler control system.

It would also be desirable to detect the status of the coupler so as to enable a visual check of the coupling status to be indicated to an operator in the cab of the excavator. This can be combined with the alarm discussed above for also warning bystanders. By detecting the status of the coupler, a mis-mount of an accessory can be detected before the operator commences onward operations.

The present invention therefore also provides a coupler for coupling an accessory to an excavator arm of an excavator, the coupler comprising a top half for attachment to an excavator arm, and a bottom half for attachment to an accessory, the bottom half comprising two accessory-pin receiving jaws, and a latch for at least one of the jaws, the latch being moveable remote from the coupler between open an closed conditions by means of at least one actuator, wherein the actuator comprises a rod and a body, the rod being for moving within or along the body, and one or more sensors for detecting the position of the rod relative to the body for determining the status of the actuator. By detecting the status of the actuator, the status of the coupler can be determined.

Preferably a latch of the coupler is associated with a blocking member for selectively blocking movement of that latch so as to restrict or prevent movements of that latch from a latching position into a non-latching position.

Preferably the coupler further comprises a first mechanism for selectively preventing movement of that blocking member into its non-blocking position.

Preferably the coupler further comprises one or more additional sensors for detecting, as appropriate, either the status or position of one or more of the following elements of the coupler: the first jaw, the second jaw, the first latch, a second latch, an orientation of the coupler, a direction of rotation of the coupler, a blocking member, a first mechanism for selectively preventing movement of a blocking member into a non-blocking position or a second mechanism for selectively preventing movement of a second latch into a non latching position.

Preferably the actuator is a hydraulic ram.

Preferably at least two sensors or markers are provided on the rod for cooperating with a marker or sensor, respectively, on the body of the actuator so as to indicate a state of extension of the rod relative to the body.

More preferably three sensors or markers are provided, or one for each stage of the actuator—corresponding to the stages provided by the blocking bar's various blocking positions.

By detecting the position of the rod relative to the body, the extent of extension of that rod relative to the body can be tracked. If the tracked status suggests an extension beyond the position corresponding to the final stage blocking position, it can be determined that the rear pin of the accessory has not been captured (otherwise the pin would have prevented that over-extension of the rod). Likewise, if none of the markers have extended past the sensor, then the rod has not extended, whereby the jaw remains open. Further, if combined with knowledge of a given pin spacing on the accessory, an inappropriate extension, within the range of available stages thereof, for that given pin spacing will indicated some other failure in the coupling—such as a non-full engagement of the a first of the pins within the rear jaw, or the other of the pins within the front jaw.

The present invention also provides an instructional device for an excavator coupler for mounting within a cab of an excavator on which the excavator coupler is, or is to be, attached, the instructional device comprising a visual display unit and memory means for storing instructional information relating to the coupler, the instructional information being for display on the visual display unit.

Preferably the visual display unit is a touch screen.

The visual display unit may comprise buttons for pressing, e.g., for changing modes or for advancing the instructions from one screen to another, or for acknowledging a completion of an instructed action.

The buttons will preferably be sealed buttons for preventing dirt and water ingress.

The instructional information can relate to a coupling procedure for the coupler.

The instructional information can relate to a decoupling procedure for the coupler.

The instructional information can comprise instructions for a lifting operation carried out using a lifting eye of the coupler.

The instructional information can comprise coupler information, including at least one of contact details for a service contractor, maintenance information for the coupler, such as greasing information or greasing instructions, and/or safety information or certification information concerning the coupler.

The instructional information may include electronic copies of instruction manuals, service manuals, safety information and/or any or all patent/manufacturer/supplier data relating to the coupler.

The instructional device may have an integrated timer circuit, for example for determining timings between steps carried out by a user.

The memory means may record such timings, and confirmations on step completions inputted by the user via the visual display unit or the buttons.

Recording timings, or actions, allows historical data to be recovered in the event of a failure or accident, whereby erroneous use of the coupler can be identified after the fact. This is highly useful for accident investigations.

The instructional device is preferably integrated into or connected to the coupler control circuits such that interactions between the user and the coupler such as via those coupler controls can also be recorded or detected, or both.

Preferably the instructional device is integrated with the above described quick coupler arrangement, or may contain features thereof, such as one or more of the sensors, or one or more of the alarm devices, or one or more of the CPU/ICU interfaces.

Preferably data recordal in relation to user actions with respect to either the coupler controls or the instructional device per se are recorded for the last 20 or more coupler condition changes, such as accessory attachments or detachments, or more preferably the last 100 or 150 such coupler condition changes. Historical use can thus be analysed to identify trends of improper use, or individual acts of improper use. This can help identify training needs.

Preferably the instructional device includes instructional information for visually displaying on the visual display unit, which instructional information includes visual indicators of the coupler's intended condition for a given step in a coupler condition change procedure, such as indicating information as to the orientation of the coupler, the status of the or each jaw of the coupler, the status of internal working mechanisms of the coupler and/or intended interactions between the coupler and the accessory, such as the pins of the accessory.

This visual information may be combined with instructional text, instructional graphics or verbal instructions or combinations of the three.

Preferably the instructional device is pre-programmed with instructional information relating to more than one design of coupler, whereby the instructional device can be a common device across a range of different excavators/excavator couplers, with the relevant instructional information being pre-selected by the installer of the equipment so as to be appropriate for the coupler in use.

Preferably the instructional device has an integrated audible buzzer and/or integrated visible lights for providing further warnings of improper use or even for indicating correct use.

Preferably the instructional device is connected to an external buzzer and/or light which may be in addition to or instead of the integrated buzzer or light and it is adapted to create a warning or indication of use whenever the instructional device is switched to an instructional mode, such as for coupling or decoupling an accessory, or for lifting using the lifting eye.

Preferably the instructional device comprises a series of instructional graphics for guiding a user step by step through a procedure, such as coupling or decoupling an accessory or lifting an item using the lifting eye.

Preferably the step by step instructions have forced time delays between sequential pages or between steps so as to force a user to consider whether each step has been correctly undertaken. In particular, steps like moving a coupler into a crowd position necessarily take time—this example generally involves a significant rotation of the coupler relative to the arm of the excavator, and having a time delay on the instruction screen that prompts that step can help to ensure that the operator does proceed with a full rotation into the crowd position—the safest condition for many steps of a coupling/decoupling process since in that position an accessory cannot self detach (an upper attachment pin of the accessory will be securely located within an upwardly facing jaw of the coupler), rather than just a partial rotation towards the crowd position.

Preferably the instructional device comprises user accessible electronic pages and user non-accessible pages, which user non-accessible electronic pages may be secured by a code or password. The user non-accessible pages may include items such as access to language control, access to maintenance and access to servicing and set up information, such as selecting which design of coupler the instructions need to be relating to, e.g. where there are more than one couplers programmed into the instruction database within the memory means.

Preferably the instructional device interfaces with signals received from sensors on the coupler, such as sensors on the jaws, the latches, the hydraulic systems or the lifting eye of the coupler, or any one or more thereof. Likewise, it could interface with orientation sensors or proximity sensors for detecting the orientation or position of the coupler relative to the cab or the excavator arm, or with the hydraulic controls themselves. The interface allows the collection of usage data. This data can be used to allow the visual display unit to show the position of the coupler on the screen effectively in real time. It also allows additional usage tracking to be performed, e.g. by storing the data in the memory means.

The memory means can be a single memory or multiple memories, and are preferably local to the instructional device, i.e. integrated inside the housing of the instructional device.

The screen can also show the condition of the coupler, i.e. the relative positions of the latches, any blocking members, any security devices or any hydraulic systems on the screen where sensors for detecting the status of those elements are provided, which sensors can also feed back to the instructional device for forming elements of the collected data.

The instructional device may provide differing visual displays or differing audible sounds depending upon the mode thereof, such as an attachment mode, a release mode, a lifting mode, a failure mode, e.g. if a departure from correct procedure is detected, or if a failure is detected in the coupler. For example, a screen could flash or an audible warning could issue in the event of such a departure from the norm.

The instructional device may comprise remote communication means, whereby it can have a interface with a third party, such as a dealer, or a manufacturer or an owner. This could be used to allow erroneous use or faults to be reported back to that third party.

An interconnection between the instructional device and the coupler can be provided. This could be made wireless by the provision of a wireless transceiver in the instructional device and a wireless transceiver in the coupler. Alternatively it can be a wired connection. Bluetooth® (or some other RF connection) would be a useful medium for a wireless connection.

The instructional device may be integrated with the excavator ECU, whereby machine management interfaces are achievable, such as a reduction or cutting of power (e.g. to the excavator hydraulics) in the event of misuse or failure.

The instructional device may have a catalogue of images of various forms of accessory therein, whereby tool recognition mechanisms incorporated into the coupler can be used to send information to the instructional device, whereby the visual display unit can illustrate not just the coupler, but also the accessory thereon. This can provide further visual feedback for the operator for ensuring appropriate coupling or decoupling procedures are being followed.

The instructional device can include a realtime clock or a GPS or the like. It can be incorporated in with the software, whereby recorded use data within the mechanism can be tagged with times and locations. Likewise, positional location available from the GPS can be used for automatic control of display languages or of an internal clock, such as by automatically updating as devices cross time zones or country borders. This is helpful for ensuring that recorded data is correct in relation to time data in any reports generated for, for example, accident investigations, or so that instructions default to the local language—these devices would be shipped from the factory to various different countries. The installer, however, would be able to override default settings.

The instructional device may include self-running fault finding circuits and alert indicators for indicating failures in the various systems of the instructional device and/or of the coupler, for example for detecting failures in sensors, failures in cables, failures in hydraulic systems, failures in energy supplies and even failures in the structural elements of the coupler, such as the frame or the latches or the lifting eye or any safety mechanisms therefor.

The visual display unit may be adapted, via the software, to provide step wise instructions, or video instructions, or written instructions, or combinations thereof, and there can be an option for selecting languages therefor. Step wise instructions will typically be given in a pictorial manner, potentially with active icons such as arrows or moving pins or moving latches or moving secondary locking mechanisms.

The visual display unit may be fitted in an excavator, or it may be supplied as a separate kit for fitting to an excavator, or it may be provided with a coupler, the instructional information including data relating to that coupler.

The present invention also provides a method of controlling an excavator coupler from within a cab of an excavator, the excavator comprising coupler controls and an instructional device as described above within the cab of the excavator, and comprising the steps of performing an action on the coupler using the coupler controls in accordance with an instruction on the instructional device and confirming on the instructional device the completion of the instructed action.

The confirmation of completion of the instructed action may be provided by the operator by pressing a button, or it may be provided automatically via sensor feedback to the system.

Preferably the instructional device records the confirmation in its memory.

These and other features of the present invention will now be described in further detail, purely by way of example, with reference to the accompanying drawings in which:

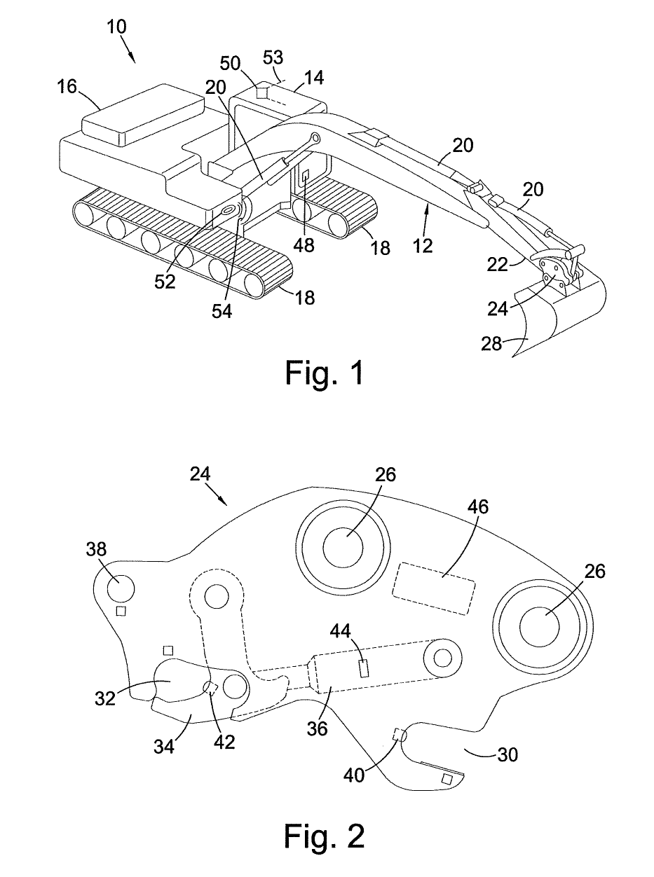

FIG. 1 is a perspective view of an excavator according to an embodiment of the present invention;

FIG. 2 is a side view of a quick coupler, such as that shown on the excavator arm of the excavator of FIG. 1;

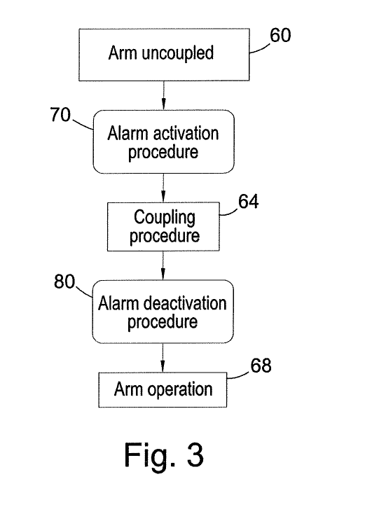

FIG. 3 is a flow chart representing a coupling procedure for excavators featuring the present invention;

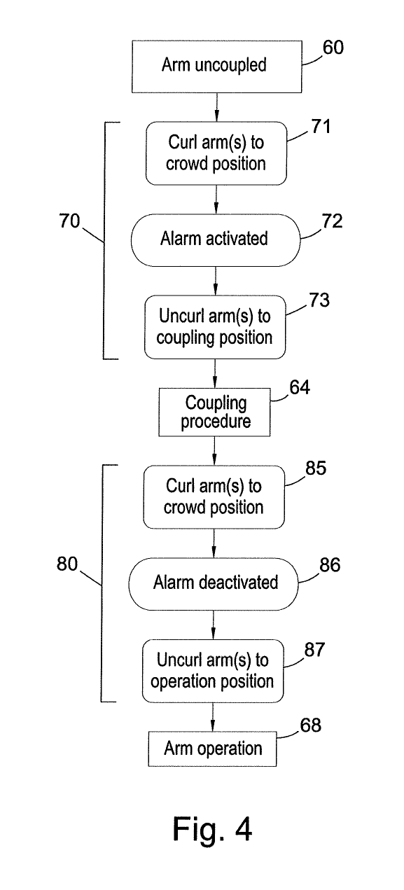

FIG. 4 is a flow chart representing alarm activation and deactivation procedures for an illustrative embodiment;

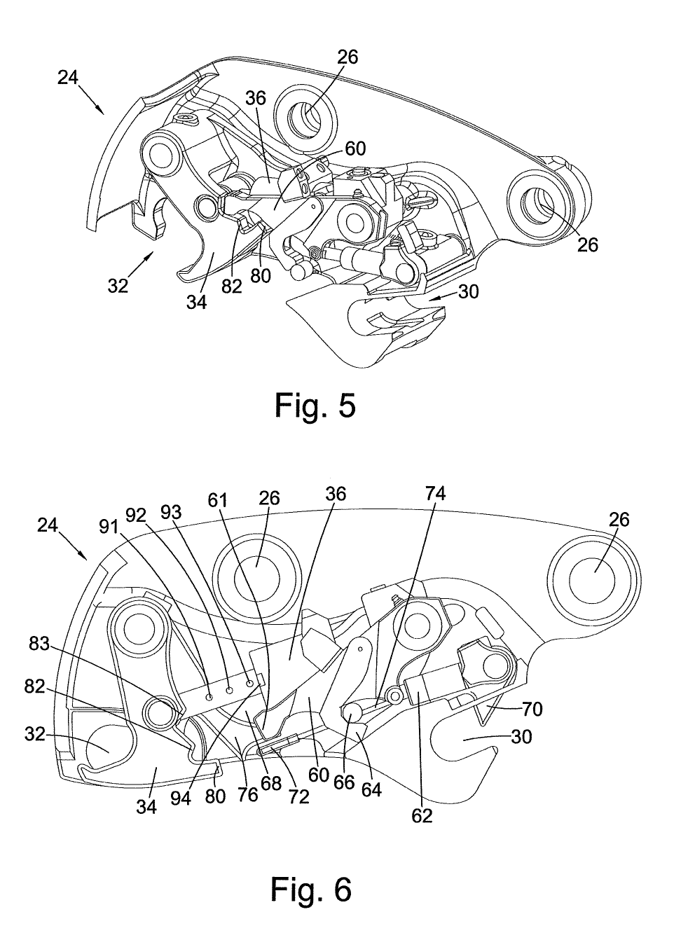

FIG. 5 is a perspective, cut-away view of a further embodiment of coupler, having features as disclosed in the above-mentioned, and herein-incorporated, GB1013155.5, illustrating further elements to monitor using the alarm of the present invention, the coupler being in a jaws open configuration;

FIG. 6 is a side elevation, cut-away view of the coupler of FIG. 6, shown in a fully jaws-closed condition;

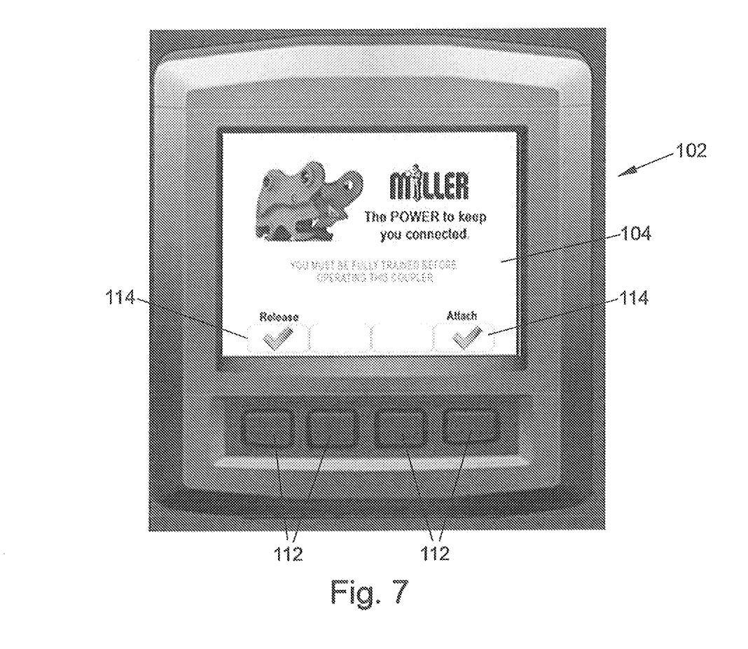

FIG. 7 shows an instructional device for locating in a cab of the excavator;

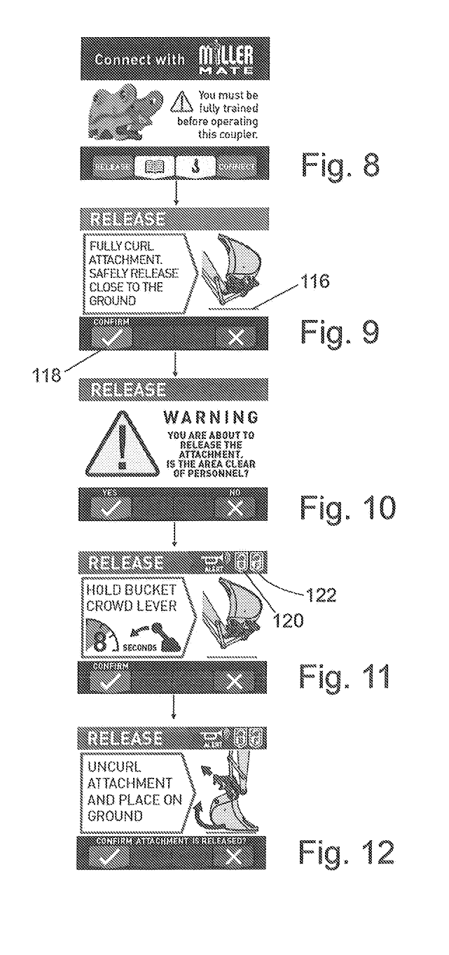

FIGS. 8 to 12 illustrate a series of instructions for a decoupling procedure that can be displayed on a visual display unit of the instructional device of FIG. 7;

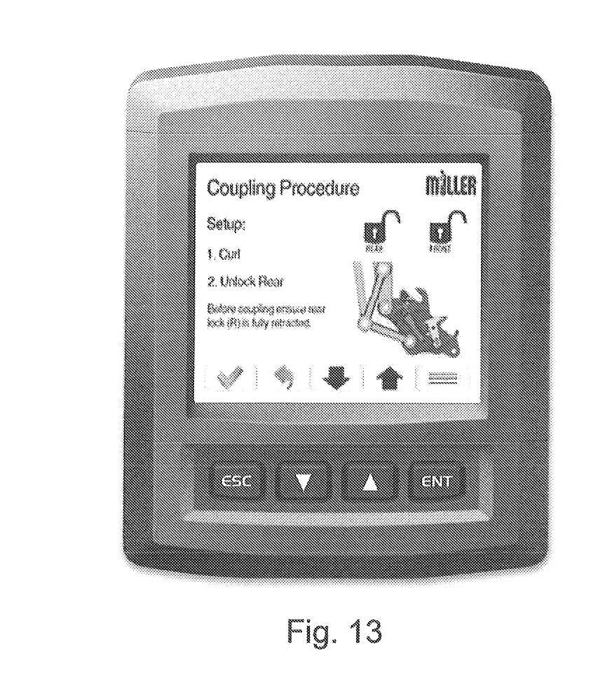

FIG. 13 shows the instructional device of FIG. 7 comprising an alternative screen display, and buttons with symbols thereon;

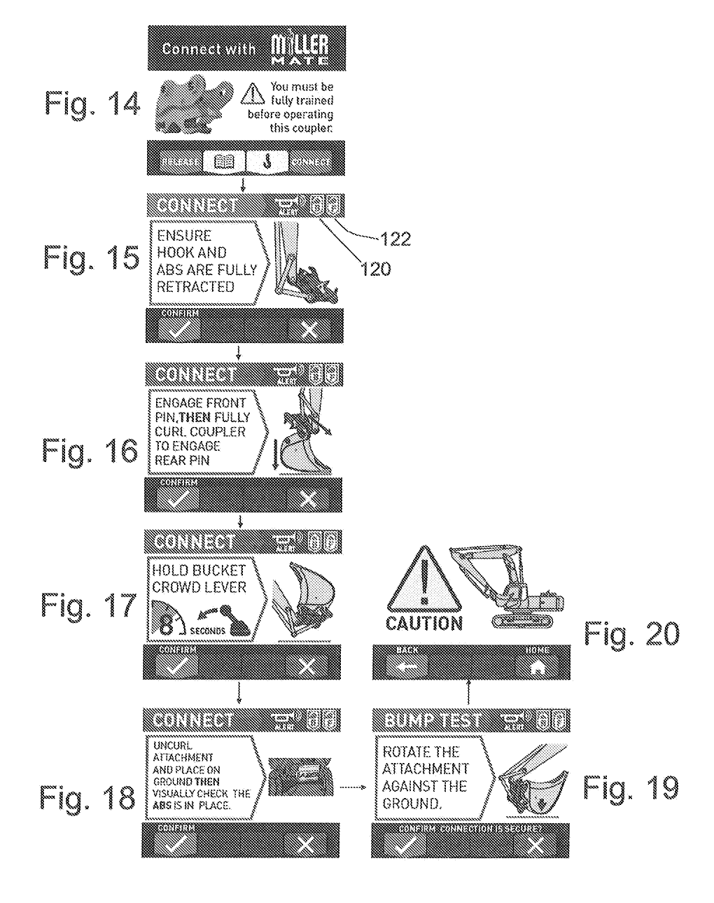

FIGS. 14 to 20 show a further series of instructions, this time for an accessory connection process;

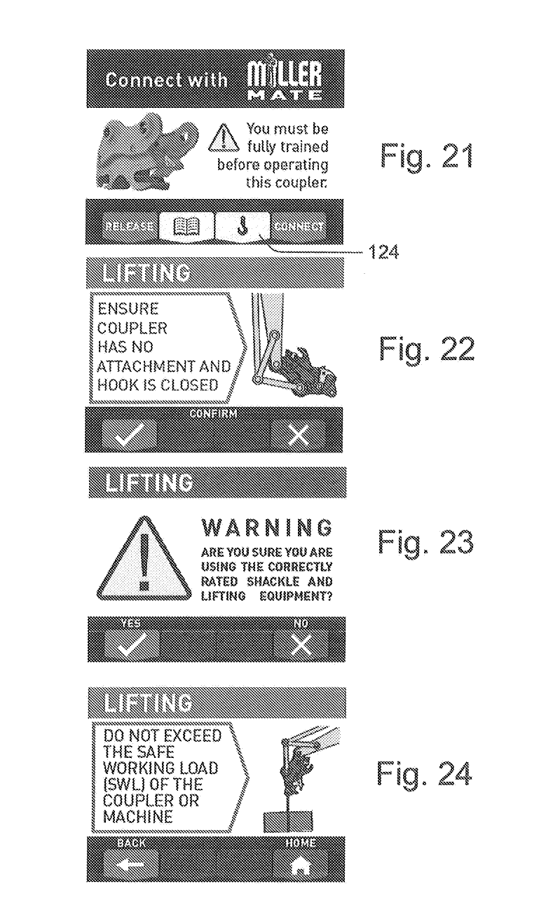

FIGS. 21 to 24 show yet a further series of instructions, this time for a lifting procedure using the lifting eye of the coupler; and

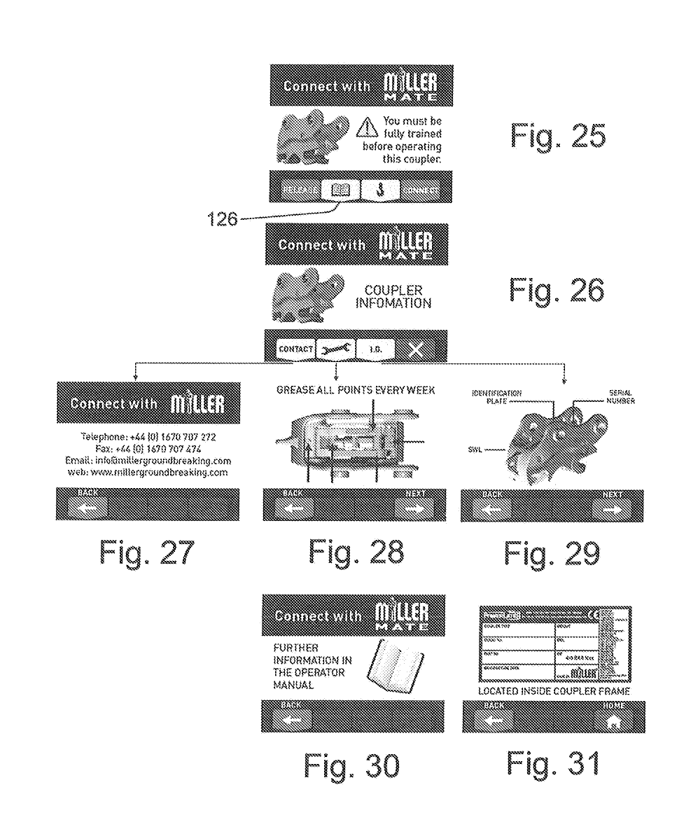

FIGS. 25 to 31 show additional screens for the visual display unit of the instructional device.

Referring first of all to FIG. 1, there is shown an excavator 10 comprising an excavator arm 12, a cab 14, an engine area 16, tracks 18 and hydraulic rams 20 for controlling the operation of the excavator arm 12.

A quick coupler 24 is attached to the free end 22 of the excavator arm 12. For that purpose, two attachment points 26 (see FIG. 2) are provided on the coupler 24, and two attachment pins (not shown) extend through those attachment points 26 for making the attachment. This type of attachment system is conventional in the art, and can apply to a number of different forms of excavator, when attaching a coupler onto the free end of the arm of those excavators.

As illustrated, an accessory 28 in the form of a bucket is attached to that coupler 24. As a result, the excavator 10, via its excavator arm 12 and its hydraulic rams 20, can be used to perform digging operations with the accessory 28.

Referring now to FIG. 2, further details of a typical coupler are shown. The coupler has the two arm attachment points 26—they are positioned in a top portion of the coupler 24. The bottom portion of the coupler 24 then has accessory attachment components, including a front jaw 30 and a rear jaw 32, each of which will engage attachment pins on the accessory 28.

The front jaw 30 points substantially longitudinally relative to the main axis of the coupler 24 (i.e. towards the cab in FIG. 1), whereas the rear jaw 32 points downwardly, i.e. towards the main body of the accessory. In use, the front or first jaw 30 picks up the accessory by hooking onto a first attachment pin of the accessory 28. Then, the second attachment pin of the accessory 28 can be swung into the open mouth of the rear or second jaw 32. Finally a pivoting latching hook 34, associated with the rear jaw 32, can be closed over that rear jaw for securing the second attachment pin as well. The orientation of the first jaw then holds the first pin therein and the accessory 28 is thus fully coupled onto the coupler 24.

Then, when necessary to decouple the accessory from the coupler, the reverse procedure is adopted, with the latch first releasing the rear pin, and then the pins being separated from their respective jaws first with the rear pin and second with the first pin.

Other embodiments of coupler can also be used with the present invention, especially where they have a coupler control circuit. Those embodiments can have secondary latching mechanisms, such as blocking bars or a latch for the front jaw as well as a latch for the rear jaw. Coupling or decoupling procedures for those couplers then instead follow the required steps for those forms of coupler, such as by needing an inversion or an actuation of a blocking member release circuit.

In the illustrated embodiment, the pivoting latching hook 34 is driven into its pin-engaging position by the coupler's own hydraulic ram, i.e. a hydraulic ram that is contained within the coupler 24. Further, the coupler includes sensing and communication technologies. They serve to provide information to the excavator driver in the cab via a display, although the information might be presented elsewhere if preferred, or used in a different manner, as it will be described below.

The information from the sensors allows the status of the coupler, or of any coupling/decoupling procedure, i.e. “work tool attachment status” to be assessed, and, possibly, reported to a control system in the excavator.

The sensing and communication technologies, in the illustrated embodiment, comprise a selection of sensors. The first sensor 40 is a sensor provided for the first jaw 30. It is for detecting whether an attachment pin is located within that front jaw 30. This could be a proximity sensor, a touch or push actuated sensor or a parameter measuring sensor—e.g. a stress or strain measurement or sensing device. It is shown in FIG. 2 to be located at the throat of the front jaw 30. It could alternatively or additionally be located near the mouth of the jaw 30, as shown by the illustrated mouth sensor 100. That mouth sensor is usefully located at the bottom jaw of the mouth, as explained later, but instead or additionally there can be a sensor in the top jaw of the mouth.

A further sensor 42 is provided for the second or rear jaw 32. In this embodiment it is primarily shown to be located in the pivoting latching hook 34. This second sensor 42 can be identical to the first sensor 40, in that it is also for detecting the presence of an attachment pin in its associated jaw—the rear jaw 32. By positioning it in the hook, it will only detect the attachment pin upon the engagement of that attachment pin by the pivoting latching hook 34. This prevents a false detection of an unsecured attachment pin. Instead of, or in addition to the sensor being in the latching hook, it may be on the rim of the rear jaw, as shown by the rim sensor 102. This can also provide an additionally useful function as discussed below. As with each sensor, it can be a point sensor or a strip sensor (e.g. following the rim of the rear jaw).

The coupler 24 of this exemplary embodiment also can have a third sensor (44), which sensor is located within or upon the hydraulic ram 36, or within or on the ram's hydraulic supply-line. This additional sensor serves to detect either or both the hydraulic pressure or the hydraulic ram extension status. Such data can serve to allow an even better picture of the coupler's status to be determined. For example, it allows the position of the pivoting latching hook 34 to be checked, or it can identify a hydraulic fluid leak. FIG. 6 discloses a variant of this, and is discussed in more detail below.

In the embodiment of FIG. 2, the first two sensors 40, 42 are adapted to sense the presence of an attachment pin in their respective jaw or hook, and the third sensor serves to detect the hydraulic pressure within the hydraulic ram 36. That sensed data is then either intermittently or continuously sent to the associated control electronics for analysis or for action, or for transmission to further control electronics such as a receiver in the cab 14.

The inventive features of the present invention will now be discussed in greater detail with reference to the additional elements disclosed in the following passages. These additional elements work and interact with the features described hereinabove.

With reference to FIG. 3 of the drawings, there is represented a coupling procedure according to the present invention. The first step of the logic chart 60 is when, initially, the excavator arm 12 (i.e. the coupler thereon) is not coupled to any accessory 28. The status of the arm is assessed by a coupler control circuit 46 or by the sensors in the coupler itself. The coupler control circuit 46 may work in cooperation with at least one of the sensors described above, normally the sensor sensing the status of the latch 34. However, any one of the other sensors discussed above may provide the required information. Alternatively, the mode of the coupler control circuit may be recognisable simply from the arrangement/condition of switches on the control box.

Referring next to FIG. 4, in order to warn operators or bystanders located externally of the cab 14 of the excavator 10 of the safety risks related to an impending coupling procedure, an alarm activation procedure is provided 70. The alarm activation procedure 70 can be started in several different manners. A preferred alarm activation method is used in this embodiment of the invention. Here, alarm activation is performed either upon putting the coupler into a coupling procedure commencement position, such as by curling the arm 12 fully into its crowd position 71, or by switching on the coupler control box. Use of the crowd position, however, has advantages since it can be an essential step in a coupling (or decoupling) procedure for disengaging a blocking member—see GB2330570.

The crowd position 71 corresponds to the state when the dipper rams 20 are fully extended, and it can therefore be sensed accordingly—by using hydraulic sensors in the pneumatic system, or in the hydraulic pump. It can also be sensed using position sensors located in the arm 12 or in the excavator 10, or by movement sensors in the coupler itself, such as ones to detect an inversion of the coupler in the correct direction (as opposed to an inversion by a full extension above and over the arm of the excavator).

Whichever the sensors are used, and wherever they are, they can be adapted to send information to a coupler control to inform it of the position or status or orientation of the coupler. In particular, they will send information to the coupler control regarding whether the coupler has reached the crowd position.

When the coupler is in the crowd position, a signal is sent by the coupler control to a central warning control system 48. The central warning control system 48 is usually located in or next to the cab 14, and could be integrated with the standard electronics of the excavator 10. The central warning control system 48 in turn informs a control system activation warning circuit that warnings 53, 54 should be issued to external operators or bystanders, to make them aware that the excavator is about to perform a coupling procedure 64. The warning circuit is not shown in the Figures since it can be acquired from stock. Consider, for example, the alarms used for reversing vehicles.

In order to issue the desired warnings 53, 54, the activation warning circuit activates one or more alarms 72 which produce one or more warnings 52, 53 directed to external operators or external people, i.e. bystanders.

It should be noted that the process illustrated in FIG. 3 is similar to that which would be used for a decoupling procedure. For a decoupling procedure, however, the start point would be a “coupled arm”, the intermediate process would be a “decoupling procedure”, and the end point would be an “uncoupled arm”.

While the alarm is on, i.e. while it is sounding or providing a visual indication of a coupling procedure mode, the excavator's operator will attend to the coupling procedure 64, i.e. he will hook the first jaw 20 of the coupler 24 to the accessory 28, and will then swing the coupler/accessory so that the rear hook also engages into its respective jaw 32, at which point the latch 34 is also then activated, by the piston or ram 36, to secure the second pin of the accessory 28 into the second jaw 32.

All of the above steps are performed while the alarm 50, 52 is active, so as to provide warnings for bystanders not to enter the environment near the excavator 10. For example, the alarm 53, 54 will put off people from approaching the excavator 10 while the excavator is performing the coupling procedure 64.

Once the coupling procedure 64 is complete, the excavator is ready for operation and the alarm 50, 52 can be switched off. To switch off the alarm, an alarm deactivation procedure 80 is provided.

A very easy implementation of alarm deactivation procedure is to switch off the coupler control circuit. An alternative, as shown in the bottom half of FIG. 4, is to again bring the coupler into a crowd position, this time while the accessory 28 is engaged to the arm 12. Being close to the cab, the crowd position allows the operator visually to inspect the coupling to verify that the coupling is correct. A further alternative can include the use of the coupler control and one or more of the hydraulic or position sensors of the arm or coupler to provide a confirmation of a completed, correct, coupling procedure, whereupon the alarm will only be deactivated when the coupling procedure has been correctly carried out.

The alarm system provided in the described embodiment of the invention comprises a light 50 and a loudspeaker 52.

The light is mounted, in this embodiment, on top of the cab 14 to increase its visibility to bystanders. It might instead be mounted, however, on either the arm or the coupler.

The loudspeaker is mounted, in this embodiment, on the frame of the excavator laterally of the arm, so that a clear sound path may be present between the loudspeaker and the addressees of the acoustic warnings. It can also, or instead, be located elsewhere.

The light and the loudspeaker may also, or instead, be combined into a single, dedicated, alarm and siren system, similar in principle to those used for house security.

Further, the loudspeaker or loudspeakers may be capable of reproducing speech warnings, i.e. warnings that are intelligible to people, such as “stay clear, coupling operations in progress!”, “stay clear of the excavator” or “stand clear—possible safety hazard!” or “stand clear, machine in motion!”. Any speech-type warnings may be pre-recorded, and could be outputted according to a predetermined sequence. For example the speech warnings may also be used not only to warn operators external to the cab of the excavator, but also to inform such operators of the operation that is being carried out by the machine, or to let them know how long there is before such an operation is accomplished.

The speech warnings may be transmitted in conjunction with any other type of acoustic warning such as siren-style warning, a white noise, an alarm bell or an alarm tone, or combinations thereof, in any sequence or fashion.

The visual or audible warning device can be part of the in-built alarm system of the excavator 10, such as by wiring the coupler warning system into the circuitry of one of the CPUs of the excavator, or it can be a retrofit unit or stand-alone unit for fitting as an ancillary item.

As shown in FIG. 1, the warning system can comprise a light emitting unit 50, such as a red or blue or yellow or orange flashing light 50, which is affixed onto the body (roof) of the excavator. It can alternatively be fitted elsewhere on the body, or onto the arm of the excavator, or multiple such lights can be provided on various parts of the body or arm of the excavator. The light should be easily be visible by bystanders.

By a flashing light, we include lights with directional flashing, such as that achieved with a rotating element within the light unit.

Although the alarm is discussed above as being turned on upon moving the arm and coupler into a crowd position, the coupling and uncoupling procedures, and the alarm therefor, may be started without having to bring the arm and coupler into their respective crowd positions, such as by triggering the alarm whenever the control box in the cab is activated. Nevertheless, many preferred automatic (or semiautomatic) couplers require a crowd position to be adopted before a coupling or decoupling procedure can be carried out, e.g. for disengaging a gravity operated blocking member. That is because that crowd position ensures that the front jaw opens upwardly, whereby the accessory 28 is still safely held within that front jaw even if the rear latch 34 is unlatched for commencing the uncoupling procedure. Therefore it is preferred to have a detection of a crowd position within the procedures of the present invention's warning system. Nevertheless, not all coupler systems have this preferred safety element, whereby, if appropriate, the warning system can be activated to sound the alarm where an unlatching of the latch can be commanded manually irrespective of the position of the coupler, i.e. at the touch of a button, such as a button on the control unit for the coupler, or upon the system sensing a movement of a latch component within the coupler. The role of the sensors 40, 42 within the coupler, or sensors within the arm/excavator/control box/hydraulic systems can thus to assist or participate in the process of alarm activation or deactivation. For example, the sensors could detect that the accessory has been decoupled successfully, and can be used to transmit that information to the warning control circuit 48, which can in turn deactivate the alarm 50, 52 without having to wait for a crowd position to be adopted for turning off the alarm.

The sensors may also be involved to confirm or check that the attachment has been coupled or uncoupled successfully, thereby preventing inadvertent or inappropriate alarm deactivations.

The above-mentioned features can also be fitted to couplers having a different internal configuration, or couplers having different latching mechanisms. Referring to FIGS. 5 and 6, one such alternative coupler 24 is shown. Its various modes of operation are disclosed in full in GB1013155.5, the contents of which are incorporated herein by way of reference. Therefore a full description of those modes of operation is not required herein. However, in brief, the coupler 24 comprises, like in the previous embodiment of FIG. 2, two arm attachment points 26 (for attachment to the excavator arm of an excavator), and two jaws—a front jaw 30 and a rear jaw 32. Further, the rear jaw 32 is associated with a pivoting latching hook 34 that is powered for movement between latching and unlatching positions by a hydraulic ram 36. The coupler 24 is also adapted to accommodate a variety of different accessories—accessories with different pin spacings between the pin centres. For that purpose, the rear jaw 32 is significantly wider than the diameter of a typical accessory's attachment pin. As such, with one pin located in the front jaw 30, the second pin of the accessory can still be accommodated in the second jaw 32 even where there is a significant variance in the pin centres, such as a range of variance of between 5 cm and 20 cm.

These features are all common to many designs of coupler, including many of those disclosed above in the above-mentioned patent applications.

In addition to those common features, however, the coupler 24 of FIGS. 5 and 6 also includes a blocking bar 60 that is powered by its own hydraulic ram 62. That blocking bar 60 also features a hook-latching hook 64 that is selectively engageable on a member 66 of the frame 68 of the coupler 24.

Further, the coupler has a second latch 70. That front latch 70 can be powered if desired, by the provision of a further ram, but in this embodiment it is instead gravity operated for movement into an open or closed condition, e.g. by rotating the coupler from a normal standing orientation as shown into a fully inverted condition (or a crowd position with respect to the excavator arm—a partial inversion).

To allow that front latch 70 to open, however, the rear hook 34 must first be retracted into a non latching position. This is to prevent the free end 72 of an arm 74, extending from the front latch 70, from engaging the underside of another arm 76, extending out from the back of that rear hook 34.

A further layer of safety, however, is also provided—in order to move that rear hook 34, the blocking bar 60 must also be powered into its open or non blocking position, as shown in FIG. 5. Otherwise the powering of the hook 34 will cause the backside 80, 82 of that hook to engage the end 61 of the blocking bar 60 (two such backsides 80, 82 are shown to reflect the fact that different accessory pin spacings can be accommodated, as taught by GB2330570, and others). The rear hook 34 can then be powered into the non latching position of FIG. 5.

In addition to that, however, there is an even further layer of safety—the hook-latching hook 64. That prevents the blocking bar from being powered into a non-blocking position whenever it is engaged with the member 66. Therefore, before the blocking bar can be powered up into a non-blocking position, the coupler must first be appropriately rotated in the anti-clockwise direction as viewed in FIG. 6. This direction of rotation is a movement towards the crowd position during normal use of the coupler on the end of an excavator arm.

The alarm of the present invention can be integrated into this form of coupler by applying any of the previously disclosed arrangements thereto, such as sensors for the jaws, or for the latching hooks or for the rams, or by applying alternative sensors, such as a sensor to monitor the position of the hook-latching hook 64 relative to the member 66, or by monitoring the proximity of the free end 72 of the arm 74 of the front latch 70 relative to the end of the other arm 76 of the rear hook 34. The condition of the second ram 62 might also, or instead, be monitored.

Many other arrangements or sensor locations can also be anticipated for the present invention.

Referring still to FIG. 6, the coupler has an actuator in the form of a hydraulic ram. It has a rod and a body, with the rod being adapted to move within or along relative to the body. As shown, the rod has three spaced markers 91, 92, 93 thereon, and the body has a sensor 94 in its gland—i.e. at the end of the body of the ram. The sensor is for sensing the movement of the markers past it, or for detecting the position of the markers relative to that sensor. The sensor can thus sense or determine or track the status of the ram.

In place of the three spaced markers, there could be three spaced sensors. More or less than three is also possible. However, in a preferred arrangement the number corresponds to the number of stages provided for the blocking bar 60—in this example, three, as signified by the three stepped surfaces 80, 82, 83 on the rear of the rear hook 34.

The three markers/sensor arrangement is provided to track the movement of the rod relative to the body of the ram 36. By doing this, the status of the actuator is constantly known, and that information can be displayed to the operator in the cab (or it can be linked to the alarm system previously described so as to sound or display the alarm in the event that there are movements through designated stages.

With this arrangement, additional warnings can be provided if the determined status of the actuator is wrong for the safe mounting of an accessory. For example, if the actuator is determined to be extended beyond the final marker, then the hook will be extended beyond a pin engaging position, whereby there cannot be a pin in the jaw. This could suggest a “pin-miss”, i.e. where the pin was not within the jaw when the hook was powered into a closed condition. Likewise if the actuator is determined not yet to have reached an expected extent of extension for a given pin spacing, then the pins may be incorrectly mounted within the jaws, or the ram may have failed.

The previously described hydraulic pressure monitoring sensor might also be provided, however, like with the first embodiment. Likewise the sensors in the jaws/latches can all be provided.

The present invention also provides, in addition to these inventive couplers, and the inventive alarm system for such couplers, an excavator (10) that has a quick coupler (24) coupled to the distal end (22) of its excavator arm (12), and methods of using the same.

In preferred embodiments, the quick coupler (24) can be operated from the cab (14) of the excavator (10), and it is connected to a warning control system (48). The warning control system (48) is connected to a coupler control circuit (46), which controls the coupler (24) and the system or circuit acquires information on the coupler's status. A control system activation warning circuit is then arranged to be responsible for issuing warning signals (53, 54) to personnel located external of the cab when the coupler control circuit (46) is activated into an accessory coupling procedure mode, or an accessory decoupling procedure mode. To do this, the warning circuit (48) is coupled to an audio and/or visual alarm (50, 52) for directing the warnings (53, 54) to the personnel, including bystanders. Thus, warnings are given to bystanders, so that they can clear the area surrounding the coupler whenever the coupler's mode of operation is made active (such as a decoupling or coupling procedure), which periods of time present an increased level of risk to the bystanders in relation to an inadvertent accessory drop event.

Referring next to FIGS. 7 to 31, a further aspect of the present invention is described. This can be combined with the above-described systems, or it can be purely instructional, or it can have its own sensors and devices for integrating with the coupler and/or the systems of the excavator.

This instructional device of the invention comprises an instructional device 102 with a visual display unit incorporated therein within an aperture of the housing thereof. The instructional device comprises a processor and memory means and stores instructional information relating to one or more coupler 24, such as those shown in FIGS. 2 and 5.

The illustrated instructional device additionally comprises four buttons, recessed relative to the face of the instructional device so as to minimise the risk of accidental pressing thereof. Those buttons can be aligned with visual buttons on the screen 104 such that when the buttons 112 are pressed, they effectively select the appropriate option on the screen 0 signified by the relevant screen button 114.

Alternatively, the screen 104 can be a touch screen, whereby a direct pressing of the screen button 114 can be used for selecting that button.

The mechanical buttons 112 are ruggedized so as to resist water and dirt ingress.

The housing is likewise ruggedized so as to protect the electronics contained therein.

Screens, housings and buttons of this type are available from companies such as Maxima Technologies, by whom various in-vehicle information clusters and displays have been manufactured.

This instructional device can be made of any desired size, although a unit having approximate dimensions of 100 mm by 120 mm by 25 mm would be adequate for the purpose.

The housing is typically formed of an engineering resin that is reinforced with the fibres and can be UV resistant.

The screen can have a safety glass front with optional anti-glare and anti-fog coatings.

The safety glass screen can be located in front of a 3½ inch (100 mm) screen (diagonal dimension), with preferably at least a 320 by 240 resolution and multi bit screen depth, for example 252 k colours. It may be backlit, e.g. with LEDs.

Other screen configurations are also possible.

A suitable processor will be provided within the instructional device, such as an ARMS 32 bit chip.

The buttons can be a plurality of tactile-form of switches, typically sealed and LED backlit so as to illuminate any markings thereon.

The information device can be connected via cables to further elements of the device or of the excavator, such as the vehicles ECU or ICU, any sensors of the coupler, or of the excavator's hydraulics, and any other devices used for inputting data into the instructional device, or for receiving data/instructions from the instructional device, e.g. for instructing a control of the power outputs of the excavator.

The instructional device may be screen mounted, dashboard mounted or integrated into the dashboard, or it may be on its own separate pedestal.

The instructional device is preferably fixed in a fixed location within the cab of the excavator upon its installation, or it might be pivotable or swivelable, although it might even be removable therefrom for external control (or for providing external instructions for control) of the coupler, such as if external controls for the coupler are provided on the excavator.

The instructional device can incorporate an internal buzzer or an internal speaker for outputting audible warnings or audible signals.

Preferably the device will be IP 67 rated at the front and IP 66 rated at the back, and as such is weather-proofed. Other weather-resistance standards might be adequate, however, for many applications of use.

The instructional device incorporates programmable memory and can be pre-programmed with instructional information relating to at least one coupler, and especially the coupler for which it is intended to be instructing actions for. It may also have an upload port (e.g. a USB port) for allowing an upload of alternative instructions, i.e. for other couplers, or for updates.

The instructions can be in the form of multiple screens, for example a series of 4 to 15 screens per mode. The device preferably has a total storage capacity in excess of 50 or even 60 instructional screen shots.

The screen shots can be adaptable to suit different OEMs, for example by having interchangeable logos thereon. Then, an instructional device installed in a Volvo excavator could be adapted to have a Volvo symbol inserted on the screen instead of the Miller symbol as shown.

Likewise, the illustrated coupler can be interchanged with differently shaped couplers or differently configured couplers, or different coupler colours (e.g. to match the colour used or required by the manufacturer of the excavator). Such changes can be customised, for example, depending upon the coupler actually in use.

With reference to at least FIGS. 9, 11 and 12, different accessories can be pre-programmed into the memory so as to present different accessories on the coupler, rather than just the illustrated bucket.

The instructional device is therefore adapted to be used by an operator of an excavator for instructing that operator in relation to the correct use of the coupler.

FIGS. 8 to 12 illustrate a first potential use of the coupler for which instructions would be useful. This use is a decoupling procedure. As shown in FIG. 8, a starting screen (here different to that of FIG. 7) is shown. These starting screens can be customisable as to user preference.

From that opening “home” screen, an operator of the excavator will press a button for selecting the release function—see the bottom left of FIG. 8. That then commences the release mode of the instructional device. The screen therefore changes first to that of FIG. 9, whereby the operator can confirm the desire to release the accessory off the coupler, while also providing an instruction to curl the attachment safely to a release position close to the ground. As shown, the picture illustrates the coupler in the crowd position (achieved by moving the bucket/coupler under the arm of the excavator into a fully curled position), and with the end of the arm of the excavator generally located very close to the ground-line 116.

Once the operator has achieved this position, he presses the confirm button 118, either by pressing the appropriate button 112, or where there is a touch screen, the appropriate screen button 114.

A further warning screen then appears for the operator to confirm that the operator is intending to release the accessory, and to request the operator to ensure that the area is clear of personnel.

Upon providing the confirmation again by pressing the relevant button—in this embodiment a yes, the audible alert warning will start to sound since the coupler is now in a disengagement mode.

The screen then switches to a further screen instructing the user how to perform the release procedure, which involves powering the ram of the coupler for releasing the two latches from the two attachment pins of the accessory (one in each jaw of the coupler). In this embodiment this is simply a matter of powering the ram, since inverting the coupler into the crowd position will have released the blocking members and any other safety mechanisms for the latches. However, other couplers may have different procedures for achieving this, or may require one latch to be powered at a time. Therefore, for that purpose a specific instruction may be provided relevant to the coupler in question.

The screen also can provide a coupler status indication—in this embodiment two latches need to be released and they can only be released when freed to do so (i.e. upon releasing any blocking devices. Since the inversion achieved that, upon the ram being powered to release the latches, this embodiment achieves an unlatched condition after the bucket crowd lever has been pushed forwards for a period of 8 seconds. This is symbolised by two padlock icons B and F 120, 122, located in the top right corner, showing themselves to be “unlocked”. The period of 8 seconds is the period required to ensure that all latches are released from the pins of the accessory.

The icons may signify an unlatched condition, or an unlocked condition, depending upon the requirements of the supplier/user.

When that unlatch procedure has been completed, the operator can again press the confirm button and the screen moves on to the next screen—see FIG. 12. During this screen, the alert warning is still sounding to ensure bystanders are clear of the area. Further, the condition of the latches is still indicated by the relevant icons.

The instructional screen further instructs the operator to uncurl the attachment/accessory to place the accessory on the ground, whereupon the rear jaw can release from the rear pin and the front jaw can then release from the front pin.

Once the user has completed that detachment procedure, he can confirm the accessory is fully released, again by pressing the relevant button.

The detachment procedure is thus then completed, and the instructional device might revert to its home page.

FIG. 13 then shows a screen for selecting a coupling procedure. However, this is jet another screen format. As can be seen, on this screen there are five options and the screen is a touch screen. There is an “accept” button, signified by a tick, a “go back a step” button (or a “go-to-home”), signified by a return arrow, “up” and “down” buttons for scrolling the screen up and down, or for moving from one step to the next, and a “written instructions” button for obtaining additional written instructions for a particular process step, or for reviewing the user manual.

Referring next to FIGS. 14 to 19, a further screen for a coupling procedure instruction is shown. This FIG. 14 corresponds with FIG. 8 above. It offers four options: a release instruction button, as previously described, an instruction booklet button, for accessing an instruction booklet, a hook button, for selecting a lift mode, and a connect button, for instigating the attachment mode of the coupler, as will now be described.

The user therefore presses the connect button for selecting the connect procedure, whereupon the screen changes to that shown in FIG. 15 and the alert sound starts to sound. Again padlock symbols 120, 122 are shown and since the latches are currently open, the icons show the back (B) and front (F) padlocks to be unlocked. However, they might have been closed, in which case they will be signified as such by closed padlocks—the user would then have to power the latches into an open condition (which might require the coupler to be curled into the crowd position first).

By making the instructional device an essential component of the coupler control circuit—i.e. accessing the controls makes the instructional device activate—the system can remember, using its memory, the previous status of the latches. Activation of the controls could therefore be made dependent upon the use of the instructional device, whereby only instructed actions can be carried out.

As shown in FIG. 15, the padlocks show the rear hook of the coupler and the ABS (or front latch of the coupler) to be open and fully retracted (see the picture of the coupler). This can be verified by the user since both latches will be visible from the cab of the excavator, in which the user will be sitting. That is the case when the coupler is in the crowd position shown (since the operator will be able to see directly into the rear jaw and will be able to see the absence of the visible part of the latch in the front jaw). The operator can then confirm that he has done a visual check, whereupon the screen then switches to the next screen—FIG. 16.

FIG. 16 instructs the operator to engage the front pin and then to fully curl the coupler to engage the rear pin. When done, the operator can confirm that he has done this whereupon the screen then switches to the next screen—FIG. 17.

Here the operator is instructed to perform a full curl of the coupler, with the accessory thereon, into the crowd position—by pushing the bucket crowd lever fully forwards for a period of 8 seconds. This additionally closes the latches—and the padlock icons B and F signify this when completed.

Upon completion of that step, the operator then presses the confirm button again and the screen switches to that of FIG. 18, which requests the operator to uncurl the attachment and place it on the ground and then visually check the ABS is in place. The ABS is visible through the mouth of the front jaw as shown in the drawing. This uncurling action can also serve to reinstate any blocking members into their blocking positions relative to their respective latch components, where provided. Until confirmed, the padlock icons may revert to an unlocked condition, as shown.

Upon confirming the ABS is in place, the operator can then press the confirm button to move to the screen of FIG. 19 which requests the operator to perform a bump test on the accessory. The bump test is to rotate the attachment against the ground to ensure that it does not come loose of the coupler. Meanwhile the alert sound is still sounding and the symbols for the locks B and F 120, 122 now show the coupler to be attached since they are both confirmed by the user as being locked.

Upon completion of the bump test, the operator presses the confirm button and the screen changes to that of FIG. 20—an optional screen to signify caution to the operator—operating the excavator arm such that the bucket hits the cab might be possible now that the length of the accessory is added to the length of the coupler. At this point the alert sound will have stopped since the attachment process has been completed.

Referring next to FIGS. 21 to 24, a third process of use of the coupler is described and instructed, and this comprises the lifting function. For this the hook button 124 is pressed. This then proceeds from the home page of FIG. 21 to the first lifting page of FIG. 22, which requires the operator to confirm that the coupler has no attachment/accessory and that the hooks on the accessory are closed. The fact that they are closed can be important since it serves to prevent an operator from using the jaws of the coupler as the means for lifting things—an improper use of the coupler since the coupler is not designed for that purpose.

Upon confirming that and pressing the relevant button, the next screen requires the operator to confirm that they are using the correctly rated shackle and lifting equipment. Again this is an important safety check.

Upon confirming that, the screen changes to that of FIG. 24 which reminds the operator not to exceed the safe working load of the coupler (or excavator arm). This screen also offers a back button and a home button since upon completion of the lifting, the operator is likely to want to revert to the home screen of FIG. 21, or may want to re-read the earlier warnings.

Finally, FIGS. 25 to 31 then disclose various additional screens that may optionally be provided. FIG. 25 is again the home screen showing the access button for the additional information—see the book button 126. That book button opens the coupler information page of FIG. 26, which provides four options, namely a contact information page, a servicing information page and an identification information page. The contact information page opens a further page—that of FIG. 27, which provides information for example of the manufacturer, although it could be the owner or the service company, or options therefor may be provided on an intermediate page. The service button pulls up instructions on for example greasing procedures for greasing all points every week, or access to additional instructional pages such as that of FIG. 30, or further pages actually physically providing the operator manual in electronic form. The ID button accesses images of the coupler for showing where to find identification information for the particular coupler in use, and that can include safe working load information, copies of identification plates, and serial number data.

The instructional device has been described above as a relatively passive instructional device. However, it could alternatively be an active instructional device by providing it with connections to sensor data from the coupler or from the excavator itself, or by linking it to the control system as suggested briefly above. Then, in place of just requiring the operator to press confirmation buttons when he has performed an instructed step, the intelligence of the coupler or the intelligence of the instructional device, or the intelligence of the control circuits, or a combination of these three features, may be sufficient to allow pages to switch from one page to the next without user input, or even to provide video based instructions that can move on as the coupling, decoupling, lifting or other procedures are undertaken and the steps thereof are completed, which video based instructions can replicate the condition of the coupler, and the operator's actions as taken. Interaction with the buttons would nevertheless still be preferred at least for the steps where the operator has to confirm that he has performed the visual or mechanical tests requested. After all, not all of the steps would be readily detectable by sensors on the coupler, on the control circuits or on the excavator.

The present invention, therefore, in this second aspect, provides in addition to the safety warnings of the first aspect of the invention, additionally an instructional device for further enhancing the safety of use of couplers.

The present invention therefore can be an excavator (10) that has a quick coupler (24) coupled to the distal end (22) of its excavator arm (12). The quick coupler (24) can be operated from the cab (14) of the excavator (10), and can be connected to a warning control system (48) or an instructional device (102). The warning control system (48) can be connected to a coupler control circuit (46), which controls the coupler (24) and the system or circuit can acquire information on the coupler's status. A control system activation warning circuit can then be arranged to be responsible for issuing warning signals (53, 54) to personnel located external of the cab when the coupler control circuit (46) is activated into an accessory coupling procedure mode, or an accessory decoupling procedure mode. To do this, the warning circuit (48) can be coupled to an audio and/or visual alarm (50, 52) for directing the warnings (53, 54) to the personnel, including bystanders. The instructional device, however, can instead instruct the operator as to how to use the coupler.

The present invention has therefore been described above purely by way of example. Modifications in detail may be made to the invention within the scope of the claims appended hereto.

1. An excavator coupler's instructional device for mounting within a cab of an excavator on which the excavator coupler is, or is to be, attached, the instructional device comprising a visual display unit and a memory storing instructional information relating to the coupler, the instructional information being for display on the visual display unit, wherein the instructional information relates to one or more of the following procedures: a coupling procedure for the coupler, a decoupling procedure for the coupler, and a lifting operation carried out using a lifting eye of the coupler, and an interconnection is provided between the instructional device and the coupler, the interconnection being either wired or wireless.

2-4. (canceled)

5. An excavator coupler's instructional device for mounting within a cab of an excavator on which the excavator coupler is, or is to be, attached, the instructional device comprising a visual display unit and a memory storing instructional information relating to the coupler, the instructional information being for display on the visual display unit, wherein an interconnection is provided between the instructional device and the coupler, the interconnection being either wired or wireless and the device further comprising an integrated timer circuit for determining timings between steps carried out by a user.

6. The instructional device of claim 1, wherein the memory records actions taken by the operator.

7. The instructional device of claim 1, wherein the instructional device is integrated into or connected to coupler control circuits such that interactions between the user and the coupler can be recorded or detected or both.

8. The instructional device of claim 1, wherein the instructional device is adapted to interact with sensors on the coupler.

9. (canceled)

10. An excavator coupler's instructional device for mounting within a cab of an excavator on which the excavator coupler is, or is to be, attached, the instructional device comprising a visual display unit and a memory storing instructional information relating to the coupler, the instructional information being for display on the visual display unit, wherein the instructional information includes information for visually displaying on the visual display unit in the form of visual indicators of the coupler's condition—either intended or actual, and an interconnection is provided between the instructional device and the coupler, the interconnection being either wired or wireless.

11. The instructional device of claim 10, wherein the coupler's condition includes information such as the coupler's orientation.

12. The instructional device of claim 10, wherein the coupler's condition includes information such as the status of one or both of the latches of the coupler.

13. The instructional device of claim 10, wherein the coupler's condition includes information such as the status of the coupler's blocking bar or blocking member.

14. The instructional device of claim 13, wherein the coupler's condition includes information such as the coupler's orientation.

15. The instructional device of claim 1, wherein the instructional information includes information for visually displaying on the visual display unit in the form of instructional text and/or of instructional graphics.

16. The instructional device of claim 1, wherein the instructional information includes verbal instructions.

17. The instructional device of claim 1, wherein the instructional information stored in the memory includes instructional information relating to more than one design of coupler.

18. (canceled)

19. The instructional device of claim 5, wherein the instructional information comprises a series of instructional graphics for guiding a user step by step through a coupler procedure.

20. The instructional device of claim 19, wherein the step by step instructions include at least one step that describes a necessary activity that takes longer than 3 seconds, the step by step instructions, for that step, having a forced time delay incorporated therefor to help ensure the step is taken.

21-63. (canceled)

64. The instructional device of claim 5, wherein the instructional device is adapted to interact with sensors on the coupler.

65. The instructional device of claim 10, wherein the instructional device is adapted to interact with sensors on the coupler.

66. The instructional device of claim 5, wherein the memory means records actions taken by the operator.

67. The instructional device of claim 10, wherein the memory means records actions taken by the operator.

68. The instructional device of claim 1, wherein the instructional information comprises a series of instructional graphics for guiding a user step by step through a coupler procedure, and the step by step instructions include at least one step that describes a necessary activity that takes longer than 3 seconds, the step by step instructions, for that step, having a forced time delay incorporated therefor to help ensure the step is taken.
